(19) United States
(12) Patent Application Publication
(10) Pub. No.: US 2018/0124735 A1
(43) Pub. Date: May 3, 2018

(54) METHOD AND SYSTEM FOR TRACKING A USER'S POSITION ALONG A PREDETERMINED ROUTE

(71) Applicant: Tom Abeles, Seattle, WA (US)

(72) Inventor: Tom Abeles, Seattle, WA (US)

(21) Appl. No.: 15/339,708

(22) Filed: Oct. 31, 2016

(51) Int. Cl. H04W 64/00

(52) U.S. Cl. CPC H04W 64/006; H04W 88/16

(57) ABSTRACT

This invention comprises a system for tracking users' position along a multitude of routes. One or more sensors placed along a known route are activated by a user, further transmitting user and/or sensor identification information to a server. As a user proceeds along the route, they activate subsequent sensors, allowing a server to track the user's position and perform other useful calculations. The system optionally includes relay sensors, which aid in wireless sensor-to-server communications over longer distances. Numerous other embodiments are provided capable of monitoring different types of routes in various circumstances.

### CROSS-REFERENCE TO RELATED APPLICATIONS

This application claims the benefit of U.S. Provisional Application No. 62/252,237, filed Nov. 6, 2015.

### BACKGROUND OF THE INVENTION

Recent consumer interest in personal health has led to a variety of personal health monitoring devices being offered on the market. Such devices tend to monitor the wearer's personal motion and bodily functions, such as steps taken or heart rate, through the use of accelerometers, gyroscopes, and biometric sensors. These devices do not provide useful feedback for activities in which knowing the user's progress along a route is necessary to understand the user's skill at that activity. While Global Positioning Systems (GPS) on cell phones and other devices allow for outdoor and large-scale orienteering, such as trail-running or backpacking, such a device would be unsuitable for indoor use or situations in which routes or obstacles are close to one another, exceeding the accuracy limitations of GPS.

An increase in popularity of route-based fitness activities such as rock climbing, parkour, obstacle courses, skiing and snowboarding, lap swimming, and others, has not been met with a rise in personal health trackers for these activities because existing devices and sensors cannot detect the difficulty or skill required to overcome a particular route or obstacle.

This disclosure provides methods and devices for tracking users' positions along predetermined routes and capturing and presenting data currently undetectable by existing fitness trackers.

### BRIEF SUMMARY OF THE INVENTION

The present invention addresses the aforementioned needs and shortcomings by providing a system by which users may easily indicate their position along a route. The system permits users to ‘check-in’ to locations along routes by scanning personal electronic identification devices on sensors located at the start and finish of routes, as well as interspersed throughout, if desired.

The sensors transmit users' personal electronic identification as well as their own unique identifier, to one or more Internet-connected servers which may further compute the location of a particular user along a route.

Using the check-in times of users, additional data may be calculated and presented to the user.

### BRIEF DESCRIPTION OF THE SERVERAL VIEWS OF THE DRAWING

The various implements disclosed herein are illustrated by way of example, and not by way of limitation, in the figures of the accompanying drawings, in which like reference numerals may refer to similar elements.

FIG. 1 is a diagram illustrating an example of a user location system capable of recording users' progress along a route according to one embodiment.

FIG. 2 illustrates an example block diagram of a location sensor which can detect a user's passive tracking device.

FIG. 3 illustrates an example block diagram of a device which cannot detect a user's passive tracking device.

FIG. 4 illustrates a high-level system architecture of a user positioning system in accordance with an aspect of the disclosure.

FIG. 5 illustrates a high-level system architecture of another user location system that contains a plurality of location sensors.

FIG. 6 illustrates a high-level system architecture of another user location system that contains a plurality of location sensors.

### DETAILED DESCRIPTION OF THE INVENTION

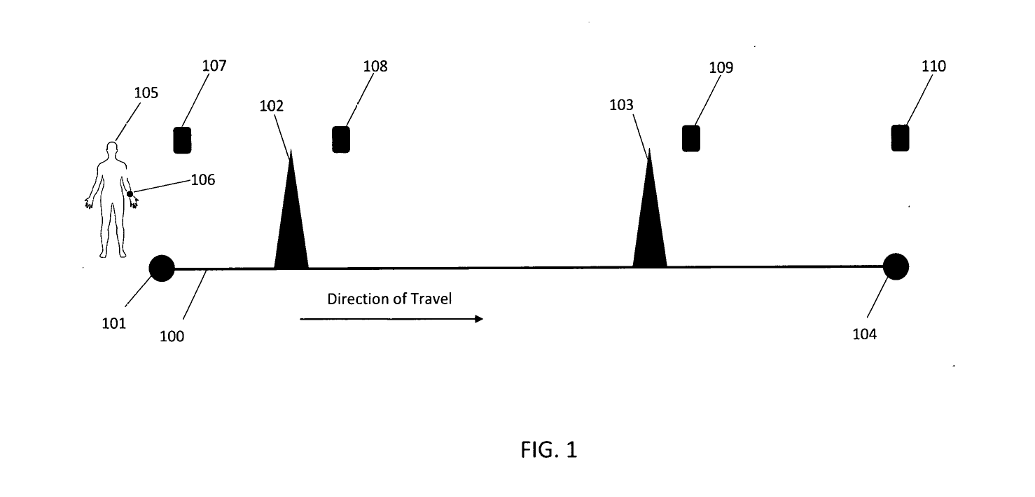

FIG. 1 is a diagram illustrating an example of a user location system capable of recording users' progress along a route according to one embodiment. As shown, route 100 is comprised of a starting location 101, several obstacles 102-103, and ending location 104. User 105, wearing passive tracking device 106 is located at the starting location. Prior to beginning the activity along the route, user 105 activates location sensor 107 which collects the unique identification information contained within passive tracking device 106. Location sensor 107 transmits its own unique identifying information as well as the passive tracking device's identifying information to one or more servers via one or more protocols (such as wired or wireless Internet, cellular, RF, or other transmission processes) (described in detail later). User 105 may now proceed along route 100, activating intermediate location sensors 108-109 as he or she encounters them and finishing by activating end location sensor 110. Upon activation, each intermediate and end location sensor 108-110 transmits its own unique identification information to server(s) via protocol(s).

In one embodiment, the system tracks the time a user has activated each sensor and, if the distance and difficulty between each sensor is known, average speed and ability may be measured. For example, consider a route several yards in length, containing increasingly difficult jumping obstacles along the route. Sensors may be placed at the start and end of the route, as well as after each jumping obstacle. If a user completes the route and all obstacles, the system may record an average speed (dividing the distance by elapsed time) and successful completion of a measurable skill by the user. If, for example, another user attempts the route and completes some but not all obstacles (and does not finish the route), similar statistics may be approximated by calculating the average speed between the start and last obstacle completed, as well as the maximum skill completed by the user. In another example, a user starts but does not complete any obstacle and does not finish the route. For this user, the system is only capable of recording an attempt.

In some embodiments, users may only attempt the route one at a time, for instance, rock climbing routes or individual obstacle courses. In such embodiments, only a starting location sensor must collect and transmit the user's passive tracking device identification. Any subsequent activations of sensors along that route may be assumed to be by the user identified by the passive-tracking device.

In other embodiments, multiple users may traverse a route simultaneously, requiring each sensor to collect and transmit each user's passive tracking device.

In some embodiments, routes have set determined start and end locations, such as rock climbing routes or obstacle courses, and a start and end sensor must be placed at its respective location in order to record route completions.

In other embodiments, routes take a circular path, for instance lap swimming or cyclical races, and only a start sensor, capable of capturing a user's passive tracking device identification and placed at the start of the circuit is necessary to record each completed circuit or lap.

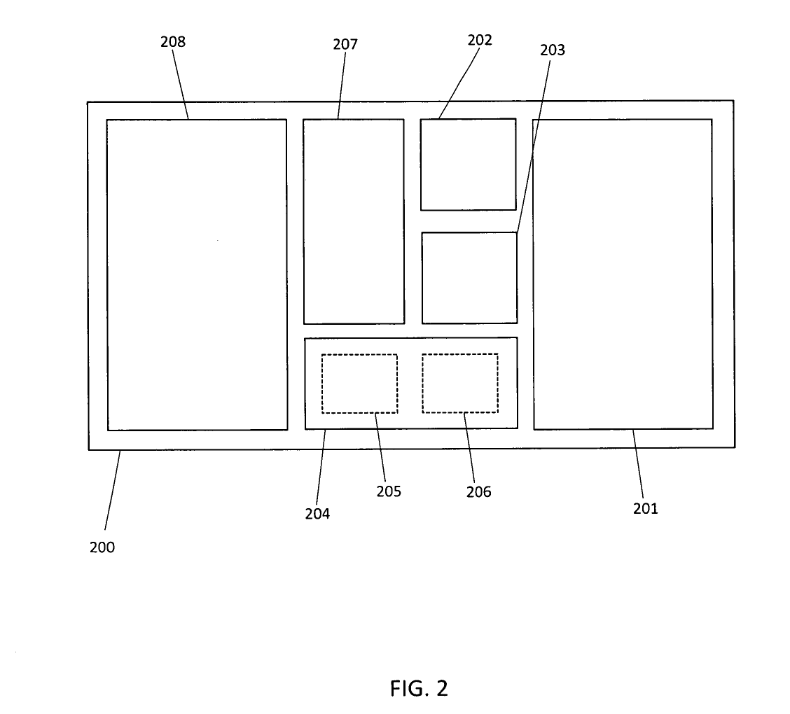

FIG. 2 illustrates an example block diagram of a location sensor which can detect a user's passive tracking device. While internal components of the sensor shown can be embodied in different hardware configurations, a basic high-level configuration for internal hardware components is shown in FIG. 2. While not shown explicitly as part of sensor 200, the sensor may include one or more external antennas and/or one or more integrated antennas that are built into the external case, including but not limited to Wi-Fi antennas, RF antennas, Bluetooth antennas, cellular antennas, satellite positioning systems (SPS) antennas (e.g., global positioning systems (GPS) antennas), and so on.

Location sensor 200 includes an Automatic Identification and Capture (AIDC) reader 201, capable of retrieving the identifier, attributes and/or data of a compatible tag when queried over a short-range interface, such as a barcode reader, Bluetooth device, Quick Response (QR) code reader, radio frequency (RF) transceiver, magnetic strip reader, RFID reader, infrared (IR) device, Near Field Communications (NFC) device, or other AIDC device.

When activated, AIDC reader 201 queries for compatible AIDC tags within its range. Upon detection of a tag, AIDC reader 201 captures and transmits the tag's unique identifier (and/or other captured data) to one or more processors 202, such as a microcontroller, microprocessor, application specific integrated circuit, digital signal processor, programmable logic circuit, or other data processing device, which will be generally referred to as processor 202. Processor 202 can execute application programming instructions within a memory 203 of device 200. Memory 203 can include one or more of read-only memory (ROM), random-access memory (RAM), electrically erasable programmable ROM (EEPROM), flash cards, or any memory common to computer platforms. One or more input/output (I/O) interfaces 204 can be configured to allow the processor 202 to communicate with and receive control from various I/O devices, such as status indicators and displays 205, and buttons or switches 206 as illustrated, and any other devices, such as additional sensors, actuators, relays, valves, switches, and the like associated with device 200.

Processor 202, upon receiving an identifier from AIDC reader 201, may further transmit its own identifier as well as the received AIDC tag identifier (and/or other captured data) via communication device 207. Communication device 207 may include one or more systems configured to communicate with an Internet-connected resource over a physical communications interface. Physical communications interfaces may include an air interface (such as those complying with a wireless Internet protocol (IP), such as IEEE 802.11, or Bluetooth protocol) or a direct wired connection (e.g., Ethernet). Each device 200 may communicate over a wired or wireless connection, or both.

Power source 208 provides electrical power necessary for the components of the device 200 to function. Power source 208 may include electricity directly supplied through cables (such as that from a standard wall outlet), rechargeable batteries and/or non-rechargeable batteries. A power source including rechargeable batteries may optionally include an energy harvesting system, capable of collection ambient or direct solar power and charging said rechargeable batteries.

One or more buttons or switches 206 are optionally included in device 200 to allow for user interaction with the device. In some instances, the device may need to be physically activated by the user, for example, to temporarily provide power to the AIDC reader 201. In other instances, AIDC reader 201 is continuously powered and user activation is not necessary. Button or switches 206 may include any type of commonly used switches, including but not limited to momentary push-button switches, biased switches, toggle switches, rotary switches, capacitive and metal touch switches, keyboards, and so on.

Device 200 also optionally includes one or more status indicators or displays 205. Status indicators or displays 205 are configured to convey information to users, and may include visual indicators, including but not limited to white or colored Light Emitting Diodes (LEDs) or Liquid Crystal Displays (LCDs), and/or auditory indicators, such as buzzers or speakers.

An aspect of the disclosure can include a device including the ability to perform the functions described herein. As will be appreciated by those skilled in the art, the various logic elements can be embodied in discrete elements, software modules executed on a processor (e.g., processor 202) or any combination of software and hardware to achieve the functionality disclosed herein. For example, AIDC reader 201, processor 202, memory 203, and I/O interface 204 may all be used cooperatively to load, store and execute the various functions disclosed herein and thus the logic to perform these functions may be distributed over various elements. Alternately, the functionality could be incorporated into one discrete component. Therefore, the features of the device 200 in FIG. 2 are to be considered merely illustrative and the disclosure is not limited to the illustrated features or arrangement.

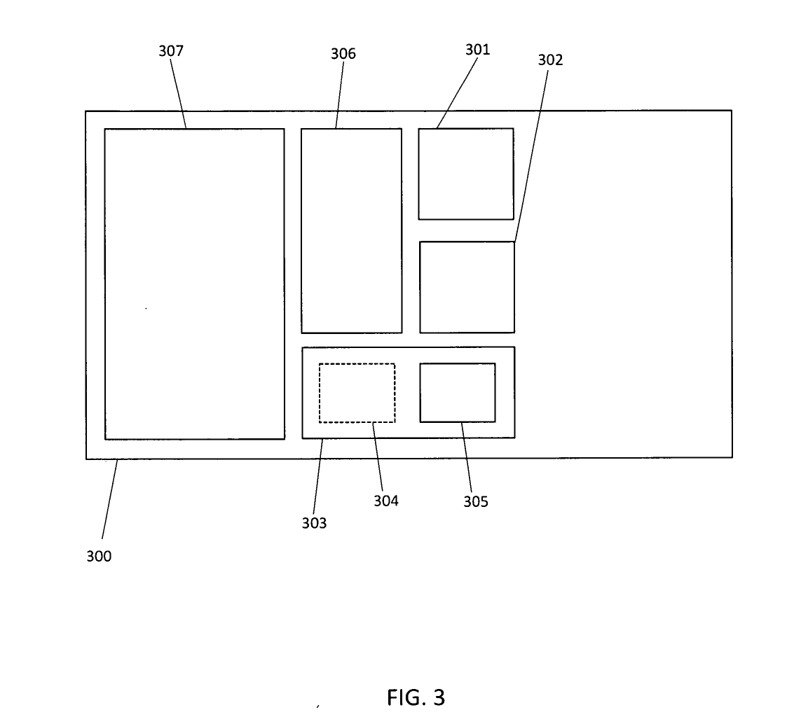

FIG. 3 illustrates an example block diagram of a device which cannot detect a user's passive tracking device. In general, the device 300 shown in FIG. 3 may include various components that are the same and/or substantially similar to the device shown in FIG. 2, which was described in greater detail above (e.g., Processor 301, memory 302, I/O device 303, communication device 306, power source 307, buttons or switches 305, and status indicators or displays 304). As such, for brevity and ease of description, various details relating to certain components in the device 300 shown in FIG. 3 may be omitted herein to the extent that the same or similar details have already been provided above in relation to the device 200 illustrated in FIG. 2.

Referring to FIG. 3, device 300 notables does not include an AIDC reader. Instead, device 300 includes one or more buttons or switches 305 to allow the user to activate device 200. Upon activation, processor 301 transmits its own unique identifier via communication device 306.

Communication between sensors and one or more remote servers may be complicated or hindered by the physical layout of routes and their environments. To overcome these obstacles, several possible configurations of sensors and servers are offered below.

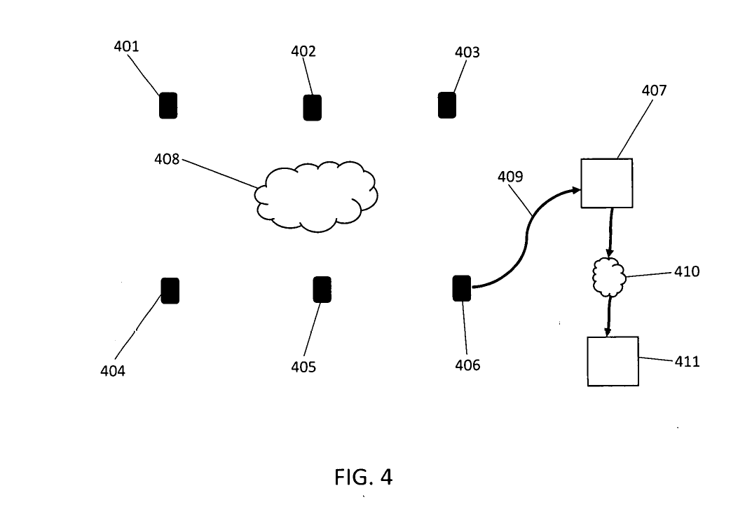

FIG. 4 illustrates a high-level system architecture of a user positioning system in accordance with an aspect of the disclosure. The system contains a plurality of sensors 401-406 configured to communicate with an access network (e.g., an access point 407) over a physical communications interface or layer, shown in FIG. 4 as air interface 408 and a direct wired connection 409. The air interface 408 can comply with a wireless Internet protocol (IP), such as IEEE 802.11. Although FIG. 4 illustrates sensors 401-405 communicating over the air interface 408 and sensor 406 communicating over the wired connection 409, each sensor may communicate over a wired or wireless connection, or both.

The Internet 410 includes a number of routing agents and processing agents (not shown in FIG. 4 for the sake of convenience). The Internet 410 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

The access point 407 may be connected to the Internet 410 via, for example, an optical communication system, such as FiOS, a cable model, a digital subscriber line (DSL) modem, cellular network, or the like. The access point 407 may communication with sensors and the Internet using the standard Internet protocols (e.g., TCP/IP). Some examples of access points include Wi-Fi routers, wired routers, and cellular towers.

A server 411 is shown as connected to the Internet 410. The server 411 can be implemented as a plurality of structurally separate servers, or alternately may correspond to a single server.

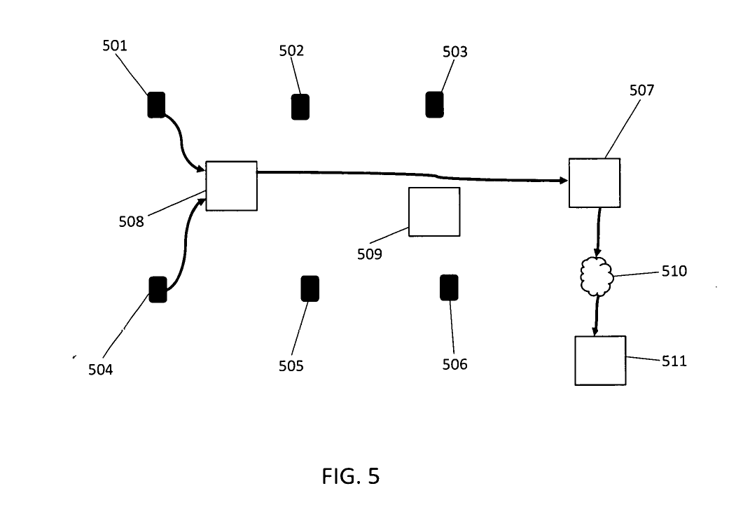

In accordance with an aspect of the disclosure, FIG. 5 illustrates a high-level system architecture of another user location system that contains a plurality of location sensors 501-506. In general, the user location system shown in FIG. 5 may include various components that are the same and/or substantially similar to the user location system shown in FIG. 4, which was described in greater detail above (e.g. the Internet 510, an access point 507 connected to the Internet 510, and a server 511 accessible via the Internet 510. As such, for brevity and ease of description, various details relating to certain components in the user location system shown in FIG. 5 may be omitted herein to the extent that the same or similar details have already been provided above in relation to the user location system shown in FIG. 4.

The user location system shown in FIG. 5 includes one or more gateway devices 508-509 that may be used to observe, monitor, control, or otherwise manage the various other components in the user location system. For example, gateway device 508 may serve as an intermediary routing point for location sensors 501, 502, 504, and 505, which may be unable to connect directly to access point 507 and communicate with Internet 510. Instead, an alternate form of communication is required between gateway devices 508-509 and user location devices 501-506 to do so; for example, a peer-to-peer network, RF transmission, Bluetooth network, Near Field Communication, or other short-range communication system. Upon receiving data from user location sensors 501-506, gateway devices 508-509 communicate with access point 507, further connecting to server 511 via the Internet 510 using standard Internet protocols (e.g., TCP/IP).

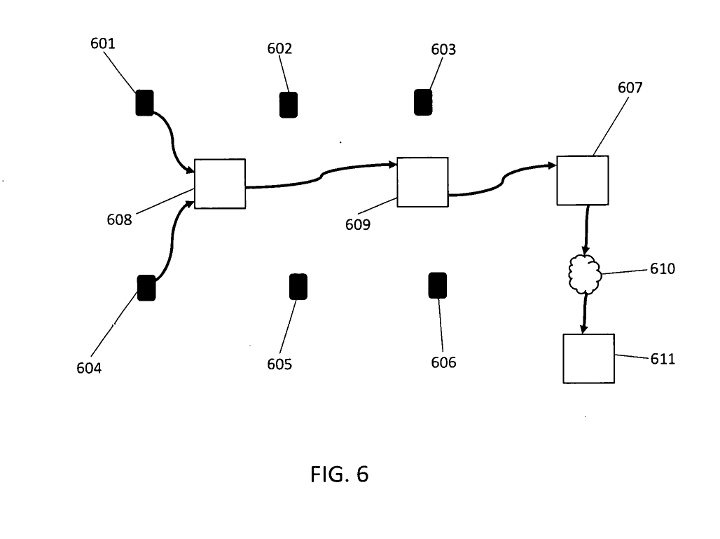

In accordance with another aspect of the disclosure, FIG. 6 illustrates a high-level architecture of another user location system that contains a plurality of location sensors 601-606. In general, the user location system shown in FIG. 6 may include various components that are the same and/or substantially similar to the user location systems shown in FIGS. 4 and 5, which were described in greater detail above. As such, for brevity and ease of description, various details relating to certain components in the user location system shown in FIG. 6 may be omitted herein to the extent that the same or similar details have already been provided above in relation to the user location systems illustrated in FIGS. 4 and 5.

The user location system shown in FIG. 6 includes one or more relay devices 608-609 that maybe used to forward data from location sensors 601-606 that are not within range of any access point 607, such as location sensors 601 and 604. For example, upon activation and identifier capture, location sensor, 601 may transmit data to relay device 608, further transmitting data to relay device 609, which in turn transmit data to access point 607. Upon receiving data from any of relay devices 608-609, access point 607 communicates with server 611 via the Internet 610 using standard Internet protocols (e.g., TCP/IP).

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method for determining a user's position along a route in which a plurality of physical locations, representing a plurality of routes, and a plurality of user location devices, each of said user location devices being associated with one of said physical locations, with at least one user location device associated with the physical location at the start of one of said routes and one user location device associated with the physical location at the end of one of said routes, comprising the steps of:
capturing, at the user location device, data representing the identification of a user;
and
transmitting, from the user location device, data representing the identification of the user and data representing the identification of the user location device to an Internet-connected server through an Internet access point.

2. The method of claim 1, wherein the user location device solely transmits the data representing the identification of said user location device.

3. The method of claim 1, wherein the user location device transmits the data representing the identification of a user and data representing the identification of the user location device to a gateway device, further transmitting said data to an Internet-connected server through an Internet access point.

4. The method of claim 3, wherein the user location device solely transmits the data representing the identification of said user location device to said gateway device.

5. The method of claim 1, wherein the user location device transmits the data representing the identification of a user and data representing the identification of the user location device to one or more relay devices, further transmitting said data to additional relay devices as needed, until said data is transmitted to a gateway or a relay device operating as a gateway, further transmitting said data to an Internet-connected server through an Internet access point.

6. The method of claim 5, wherein the user location device solely transmits the data representing the identification of said user location device.

7. An apparatus for capturing and transmitting data representing the identification of a user and data representing the identification of said apparatus, comprising:
an Automatic Identification and Capture Device reader;
a processor;
memory;
a power source;
an I/O interface; and
a communication device.

8. The apparatus of claim 7, further comprising a plurality of switches, each of said switches being connected to said I/O interface for controlling said apparatus.

9. The apparatus of claim 7, further comprising a plurality of status indicators of displays, each of said status indicators or displays being connected to said I/O interface of said apparatus.

10. An apparatus for capturing and transmitting data representing the identification of said apparatus, comprising:
a processor;
memory;
a power source;
an I/O interface; and
a communication device.

11. The apparatus of claim 10, further comprising a plurality of switches, each of said switches being connected to said I/O interface for controlling said apparatus.

12. The apparatus of claim 10, further comprising a plurality of status indicators of displays, each of said status indicators or displays being connected to said I/O interface of said apparatus.
